(19) United States
(12) Patent Application Publication
(10) Pub. No.: US 2017/0053082 A1
(43) Pub. Date: Feb. 23, 2017

(54) METHOD FOR PREDICTION OF A PLACEBO RESPONSE IN AN INDIVIDUAL

(71) Applicant: Tools4Patient SA, Gosselies (BE)

(72) Inventors: Alvaro Pereira, Fleurus (BE); Dominique DeMole, Cortil Wodon (BE); Chantal Gossuin, Rohde-Saint-Genese (BE); Thibault Helleputte, Limal (BE)

(73) Assignee: Tools4Patient SA, Gosselies (BE)

(21) Appl. No.: 15/308,502

(22) PCT Filed: May 5, 2015
(86) PCT No.: PCT/EP2015/059875

§ 371 Date: Nov. 2, 2016

Related U.S. Application Data
(63) Continuation of application No. 14/269,503, filed on May 5, 2014.

(30) Foreign Application Priority Data
May 5, 2014 (EP) 14167021.6

(51) Int. Cl. G06F 19/00; G06N 7/00; G06N 99/00

(52) U.S. Cl. CPC G06F 19/345; G06N 99/005; G06N 7/005; G06F 19/3437

(57) ABSTRACT

The current invention concerns a method for predicting a placebo response in an individual, comprising collecting data via—querying said individual on personality and health traits; and/or—performing one or more social learning and/or (bio)physical tests on said individual; characterized in that said data is used in a mathematical model stored on a computer for computing a correlation between the input data, thereby attributing a Scoring Factor to said individual, whereby said Scoring Factor is a measure of propensity to raise a placebo response and/or a measure of the intensity of said response.

### TECHNICAL FIELD

The invention pertains to the technical field of methods for providing improved therapeutic treatments and improved clinical trials for therapeutic treatments. More particularly this relates to methods for predicting placebo response or effect and to systems providing such predictions and using the generated data of the predictions.

### BACKGROUND

The clinical development of new drugs or treatments in major therapeutic indications such as chronic pain (including neuropathic pain, migraines...), mental disorders, depression, epilepsy, Parkinson, asthma is complex and is not efficient.

This is mainly due by the fact that many Phase 2 and 3 clinical trials are abandoned or fails because of safety or the inability to demonstrate clear superiority of the tested drug versus a placebo despite promising results observed in vitro and/or in pre-clinical studies. The reason for this is that, in therapeutic fields such as e.g. pain or depression, the placebo response by itself has a pronounced effect on the primary outcomes of the clinical studies. More specifically, one recognizes today that the investigator behavior vis-á-vis its patient as well as the patients expectations (in terms of drug efficacy and overall well-being) have a profound impact on the patient assessment regarding the efficacy of the medication.

Hence the steep rise in attrition rate of drug development is a major concern for both clinicians and pharmaceutical companies that face major difficulty of obtaining market authorization of new drugs in nowadays prominent therapeutic fields such as e.g. pain and depression. On the standpoint of the health care attendant, managing properly the placebo effect/response may positively contribute to the better well-being of its patients. On the standpoint of the pharmaceutical companies, controlling the placebo effect is essential to design appropriately clinical trial to allow a clear differentiation between, on the one hand, the physiological effect of the studied drug and, on the other hand, the other effects collectively referred to as the placebo effect.

Altogether, (i) the high impact of the placebo response on the drug efficacy evaluation and (ii) the absence of common traits among patients that allow to measure, at the level of a population, to which extent the placebo response interferes with the physiological assessment of a new drug candidate make it very difficult to demonstrate its superiority. As a result, both clinical research scientists and pharmaceutical companies need improved clinical studies designs and improved patient's characterization able to differentiate the placebo response from the physiological effect of the tested drug.

It was found that the placebo effect is multifactorial in nature. On the one hand the effect is a learning phenomenon, which is influenced by the manipulation of different variables including patient expectation, (bio)physical, prior experiences, observational and social learning as well as personal traits. Hence, the placebo effect is mainly patient-dependent. Each individual may demonstrate a different response based on his/her therapeutic history and personality related aspects.

It was furthermore found that the placebo-effect is disease dependent, whereby an individual will show an effect which differs from disease to disease.

It was furthermore found that the placebo-effect is time dependent, whereby an individual will show a placebo response which evolves with time or time of treatment. Hence patients may respond to a placebo effect differently at the start of a treatment compared to the level of response during or at the end of a treatment. Individuals who respond to placebo or who demonstrate a propensity to said ‘response shift’ or response drift may be more amenable to lower dosages, improved therapeutic outcomes, higher self-reported perceived improvements, quality of life or the like.

Similarly, an individual may show a nocebo effect which evolves with time or time of treatment. Hence patients may respond to a nocebo effect differently at the start of a treatment compared to the level of response during or at the end of a treatment. Individuals who respond to nocebo or who demonstrate a propensity to said ‘response shift’ or ‘response drift’ may be more amenable to higher dosages, decreased therapeutic outcomes, lower self-reported perceived improvements, quality of life or the like.

Several questionnaires, biophysical tests or virtual reality tools have already been developed and used to assess some aspects of the placebo effect in an individual. However, because of their stand-alone and very narrow nature, these questionnaires and biophysical tests do not allow giving an accurate estimation of a placebo effect present in the individual.

WO 2005027719 describes a method for predicting the predisposition to a placebo effect, based on biological markers. The method is very one-sided, and does not take into account the multifactorial nature of the placebo effect.

WO 2013039574 describes a method for selecting participants for a clinical trial whereby the participants are screened based on their responsiveness to placebo treatment. The method in WO 2013039574 thereto makes use of an assessment of the bodily self-image or self-identity, e.g. an individual's perception of their own self in relation to, or in relationship with their body. The method described in WO 2013039574 is one of the methods available in the prior art to classify subjects among placebo responders and non-responders but relies only on the assessment of the adaptability of a subject's perception of its bodily self-image. The assessment according to WO 2013039574 fails to provide a method relying on the proper understanding of the inter-relationships between various factors either psychological or physiological in nature that contribute to a placebo effect. Accordingly WO 2013039574 fails to describe a subject's global and unbiased placebo response signature or pattern.

US20140006042 describes a methodology for conducting studies, thereby generating a placebo responder index. The index is obtained by comparison of data obtained from a patient with previously obtained data. Having to use a comparative approach for determining a putative placebo response is not desired as such comparison has to rely on previously obtained data. If such previous data is flawed or there is even the slightest difference in the test circumstances, than the comparison may lack in trustworthiness. Moreover, a deviation in result can occur if the compared data does not originate from the same individual. This can give a distortion in the obtained result.

Currently, either for decreasing the level of attrition rates in clinical trials or for improving the accuracy of the contribution of the physiological effect of a (drug) treatment to the overall response of a patient when treating diseases where placebo effect intervenes or, more generally, for improving a treatment of diseases where placebo effect intervenes, the prior art inappropriately solves the problem of accurately defining the propensity of a subject to raise a placebo response or to reveal a placebo effect. Secondly, the existing methods, especially the questionnaires, are time-consuming and put a heavy burden on the patient having to undergo the testing.

The present invention aims to resolve at least some of the problems mentioned above.

### SUMMARY OF THE INVENTION

The current invention aims to provide a method and tool, for predicting the propensity of a placebo effect in an individual, said prediction is built on a multifactorial approach of traits which are related to the placebo effect. The methodology and tool start from a predefined amount of data, obtained from the individual, which is used in a mathematical model to define a correlation between the input data, whereby the correlation enables to provide a measure of the placebo response. The invention offers a means for generating an accurate placebo score using a limited number of input variables. It has been surprisingly observed that the relationship between input variables (correlations or other forms of mathematical relationships between two or more random variables or data points) can be used to have a “straightforward” prediction of the placebo response (without “undue” questioning the patients).

Because of the multi-facet approach of the current invention, said prediction is more reliable than the other methods currently known in the art. As it is based on a correlation of inherent characteristics and data obtained from one individual, often on a specific time point, thereby omitting the necessity of comparing the latter with previously obtained data (e.g. from other individuals), the latter is more trustworthy. Hence, the results of the current method can be deployed in various stages of patient treatment and/or clinical trials, including for balancing the placebo responders in various groups (arms) of a clinical study, all of which are known to be affected by a placebo effect. The current invention relates thereto to a method for predicting a placebo response in an individual, according to claim 1. In further aspects, the current invention also relate to a computer implemented method and product and a companion diagnostic tool. The current invention also relate to methodologies that can be used in clinical trials or for improving the quality of the results of the latter.

### DESCRIPTION OF FIGURES

FIG. 1 shows a schematic overview of an embodiment of the methodology according to the current invention.

FIG. 2 shows a screenshot of a computer interface according to an embodiment of the current invention, whereby the intensity of a placebo response is predicted based on input traits.

FIG. 3 shows a decision tree following example 2.4.

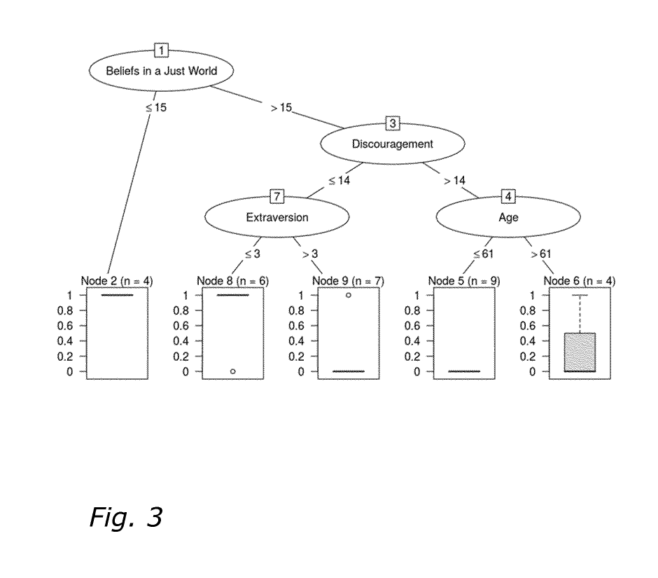

### DETAILED DESCRIPTION OF THE INVENTION

The present invention concerns methodologies for determining a placebo effect in an individual, or to determine the propensity that an individual has to respond to a placebo effect. The importance of the placebo effect in clinical trials and in patient therapy has only begun to be acknowledged in the last decade. Some of the neuroanatomical and neurophysiological substrates of the placebo effect have been elucidated in the past years, but development of prediction tools for placebo effect have until now been largely underexposed. It is the aim of the current invention to develop a methodology and system for predicting a placebo response in an individual and for implementing the latter in drug design and clinical trials.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight” (weight percent), here and throughout the description unless otherwise defined, refers to the relative weight of the respective component based on the overall weight of the formulation.

The current invention thereto provides for a method for predicting a placebo response in an individual. Said method may comprise collecting data via the following steps:
querying said individual on personality and health traits; and/or
performing one or more social learning and/or (bio)physical tests on said individual.

In a preferred embodiment, a Scoring Factor will be attributed to said individual, whereby said Scoring Factor is a measure of propensity to raise a placebo response and a measure of the intensity of the response. To that purpose, the data obtained is used in a mathematical model, the output of said model being the Scoring Factor.

This is different from what is currently known in the art. To date, no mathematical model or tool for qualifying, quantifying and/or predicting the placebo effect of an individual exists which takes into account a subset of aspects that contribute to the placebo effect such as the individual's personality traits, health traits, (bio)physical measures etc. Questionnaires taken alone or (bio)physical tests used alone currently used never give a value for a placebo effect, as they are stand-alone approaches. Not only do they fail to take into account the multifactorial nature of the placebo effect but if the skilled person of the art decides to use them all (together or sequentially), he will fail in providing a measure of the placebo effect since conducting the corresponding surveys and tests is not feasible.

In the context of the current invention, the terms ‘predicting’ and any derivatives thereof (predictive, prediction...) is to be understood as providing a probabilistic picture of an analysed feature, said picture is preferably computed by a model. Alternatively or in addition, predicting is to be understood as anticipating the evolution of said feature in time or during a predefined time period.

For the purpose of current invention, the term ‘pain disorder’ is to be understood as an acute or chronic pain experienced by a patient. Said pain disorders may be subdivided in three groups:
Pain associated with psychological factors
Pain associated with psychological and a general medical condition
Pain disorder associated with a general medical condition

Hence, said pain:
may be caused by damages or diseases that affect the somatosensory system (neuropathic pain);
from activation of nociceptors (nociceptive pain);
caused or increased by mental, emotional or behavioural factors (psychogenic pain);
breakthrough pain, e.g. caused by cancer; or
arising from a sudden activity (incident pain).

For the purpose of the current invention, said ‘correlation’ or ‘correlating’ is to be understood as a mathematical relationship between two or more random variables or data points. Preferably, said correlation is predictive or allows identifying a predictive relationship between the analysed variables.;

In the context of the current invention, the term ‘Placebo’ can be any of typically inert or active substances, formulations, drug-based therapies or non-drug-based therapies administered to, given to or used by a patient, e.g., tablets, suspensions or injections of inert ingredients, e.g., sugar pills or starch pills, or other mock therapies, e.g., fake surgeries, fake psychiatric care, or others that have been used, typically as controls, for a putative “real” treatment (in order to obtain a purported, supposed, or believed therapeutic effect on a symptom, disorder, condition, or disease, or prescribed, recommended, endorsed or promoted, knowingly or unknowingly, to another, notwithstanding that the therapy is actually ineffective for, has no known physiologic effect on, or is not specifically effective for the symptom, disorder, condition, or disease being treated).

In the context of the current invention, the term ‘Placebo effect’ means any specific or non-specific psychobiological phenomenon attributable to the placebo and/or to the treatment context irrespective to the fact that the placebo is actually administered or not. The placebo effect as meant in the context of the current invention highlights the central role of expectations and suggestions in placebo-related phenomena and diseases.

In the context of the current invention, the term ‘Placebo response’ means the outcome of the placebo effect as expressed, perceived or measured by one or more individuals for qualifying or quantifying either the improvement or the deterioration (nocebo response) in a symptom or a physiological condition in the context of the administration of a placebo and/or a treatment.

Said Placebo response not only includes the presence or the absence of the response itself but equally relates to the intensity of the response that is given or expressed by the individual.

Said placebo response may be disease-dependent and/or time-dependent.

In the context of the current invention, the term ‘response shift’ or ‘response drift’ means a change in the placebo response along a treatment, a clinical trial or any health-related intervention.

In the context of the current invention, ‘trait or traits’ is to be understood as all kinds of variables, whether or not directly linked to an individual, which can be inputted in the model according to the current invention, and which are used to come to the Scoring Factor. More in detail, said traits are identified by a skilled person based on current understanding of different aspects potentially related to a placebo aspect, and commonly collected with existing questionnaires and/or tests.

In the context of the current invention, ‘personality traits’ is to be understood as the characteristics of an individual which relate to the psyche of the individual, the physical characteristics of said individual and/or the personal background information of that individual. Said characteristics of the psyche may include, but are not limiting to emotional characteristics, behavioural characteristics, general beliefs of the individual and/or emotional traits.

Said health traits may include all health related information of the individual, as well as of family of the individual. Said health traits may for instance include, but are not limiting to past and current diseases, received treatments, current and past medicinal use, potential health risks, genetic predisposition for disease development, etc.

Within the context of the current invention, said social learning might be understood as a process in which individuals observe the behaviour of others and its consequences, or specific situations and models to modify their own behaviour accordingly. Said social learning test includes providing an individual with behavioural, environmental and/or exemplary information or stimuli, thereby eliciting (or not) a response in said individual, based on the information received.

In the context of the current invention, said (bio)physical test is to be understood as any test, relating to the measurement or detection of a biophysical parameter. For instance, said (bio)physical test may include but is not limited to measuring or analysing a biological compound of said individual; measuring or detecting a biological reaction of said individual; performing a neurological test on said individual; measuring or detecting a sensory reaction; performing a tactile test on said individual.

For instance, the Somedic Thermotest apparatus (Somedic AS, Stockholm, Sweden) may be used to deliver quantified and reproducible heat impulses via a 2.5×5 cm (12 cm2)—Peltier thermode applied to the thenar eminence of the non-dominant hand.

By preference, said (bio)physical test involves a neurological, somatosensory, tactile or analytical test, or virtual reality tools or any combination thereof.

Examples of such objective tests may include heart rate monitoring, blood pressure monitoring, monitoring respiration, measuring one or more components or metabolites of blood (e.g. blood chemistry) or other bodily fluid, measuring skin parameters such as blood flow, temperature, or conductance; or other physiological measures including measuring any brain or neurological activity, skin conductance resonance (SCR), electroencephalography (EEG), quantitative EEG (QEEG), magnetic resonance imaging (MRI), functional MRI (fMRI), computed tomography (CT), positron emission tomography (PET), electronystagmography (ENG), single photon emission computed tomography (SPECT), magnetoencephalography (MEG), superconducting quantum interference devices (SQUIDS), electromyography, eye movement tracking, and/or pupillary diameter change, pain tests such as for instance heat pain procedure.

In the context of the current invention, said Scoring Factor is to be understood as a measure for a certain analysed feature (in the current case the propensity to exhibit a placebo effect or response). Said Scoring Factor may be a numerical factor or parameter, being an indication of the analysed feature based on a specific scale, whereby the higher (or lower) the numerical factor resides on the scale, the more likely it is that the analysed feature is present. For example, in the context of the current invention, said Scoring Factor may provide a scale with regard to the propensity of an individual to be eligible for a placebo effect. In another embodiment, said Scoring Factor may be a classification of an analysed individual. For example, in the context of the current invention, said Scoring Factor may determine whether an individual is a responder or non-responder to a placebo effect (‘yes’ or ‘no’). In yet another embodiment, said Scoring Factor is a profile or outline of the Placebo response. In general, said Scoring Factor is a (predictive) value (e.g. a colour code, a definition, a term, a numerical factor . . . ) of the placebo response or placebo effect of an individual.

In an embodiment, said Scoring Factor will be compared to one or more cut-off values or thresholds, in order to determine whether a placebo response is present in an individual. If said Scoring Factor is higher than a predefined cut-off value, this indicates the presence of a placebo response, or a high propensity of developing the latter.

If the scoring Factor is situated in below the cut-off value, but above a second cut-off value, then a placebo response might be present. Below the second cut-off value, a placebo response is not present.

In another embodiment, said Scoring Factor will be mapped on or compared to a predefined scale, whereby the height of the Scoring Factor is directly proportional to the propensity of developing a placebo response or the presence of a placebo response in the individual.

The current method has as advantage that it offers a model for a placebo effect or response, thereby adopting a multifactorial and multi-integrated approach. Models for the placebo response have focussed until now on a very limited amount of information, and studies have failed to provide a coherent link with the data gathered and the placebo response as such. The current methodology and tools derived thereof strive to take into account multiple facets of the placebo effect, thereby offering a reliable tool, for predicting a placebo response in a vast amount of medical indications. To that purpose, the current invention describes a methodology and tools which make use of objectified data (e.g. obtained by testing and/or questioning an individual), and which is to be considered as the ‘input’ for the final prediction.

In a preferred embodiment, said method will include data from:
one or more personality queries;
one or more health queries;
one or more social learning tests; and
one or more (bio)physical tests
   relating to or performed on an individual.

In another embodiment, said method comprises any combination of 2 or 3 of above queries and/or tests.

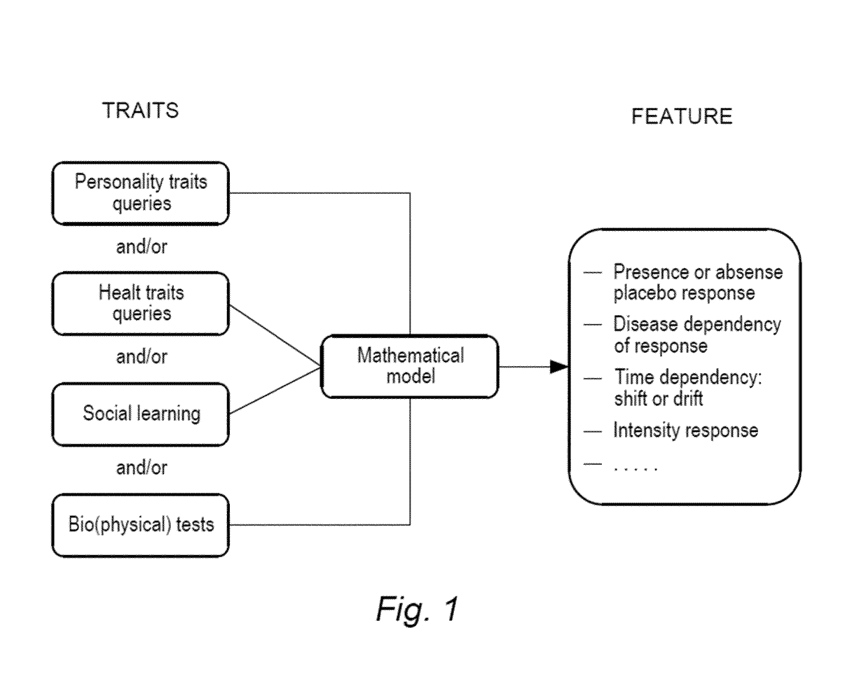

FIG. 1 shows a schematic overview of a possible methodology according to the current invention.

In an embodiment, said personality query comprises one or more questions selected from clusters of questions for characterizing an individual's personality traits or characteristics which are stable over time and attributable to a person itself and not to the effect of its environment. Said cluster of questions related to personality comprises one or more questions for measuring the Big Five components (readily known in the art) of personality namely individual's openness to experience, conscientiousness, extroversion, agreeableness, and neuroticism (or emotionality), all of which are well-known to the skilled person in the art.

In another embodiment, said query comprises one or more questions selected from clusters of questions for measuring or evaluating the impact of an individual's surrounding on its perception of health-related issues.

Said cluster of questions related to the impact of the surrounding comprises:
one or more questions for measuring the impact of the caregiver's behaviour (agreeable, open, severe..) or intervention (oral, acts...),
one or more questions relating to the sensation of contagion, suggestibility or any other factor likely to influence the balance between deliberate and automatic processing of information on a health symptom onset, evaluation, relief, evolution . . . .
one or more questions for evaluating the level of anxiety, fear, discouragement, hopelessness, depression related to the environment of a clinical setting or a caregiver.

In another embodiment, said query comprises one or more questions selected from clusters of questions for evaluating the impact of an individual's environment on his belief of a just world, psychological well-being, psychological quality of life, life satisfaction, resistance to stress and depression...

In another embodiment, said query comprises one or more questions selected from clusters of questions for measuring the individual's expectations with respect to an external stimulus, positive and negative outcomes of an intervention or a treatment, and for evaluating his propensity to have a positive or a negative attitude with respect to external factors or health symptoms, specific treatments to relief health symptoms . . . .

In another embodiment, said query comprises one or more questions which are asked after exposing said individual to either expectation-influential or neutral information. For the purpose of the current invention, said information includes all information, directly or indirectly related to the performed test and/or the placebo given and mode of action of said placebo.

In another embodiment, said query comprises one or more questions selected from clusters of questions for evaluating the attitudinal and emotional response of an individual to external stimuli. Said cluster of questions comprises questions for measuring the level of control that the individual believes to have on his life, the level control of external factors or health symptoms on his life such as luck, fate, life events or powerful others (such as e.g. relatives, health professionals, colleagues at work etc.) and for measuring the level of control of powerful others such as relatives or social learning . . . on his attitude to resist, fight or overcome aggressive external factors or health symptoms.

In another embodiment, said query comprises one or more questions selected from clusters of questions for evaluating the level (severity) of health symptoms.

Said such cluster of questions may comprise one or more questions for measuring to which extent the individual estimates that health symptoms influence his general physical and psychological condition comprising his body function, activity, mobility, working ability, relations with other people, sleep, life satisfaction, mood, . . . , and to which extent the influence of the health symptoms on his general condition evolve with time.

In yet another embodiment, said such cluster of questions may comprise one or more questions for evaluating to which extent the caregiver estimates that health symptoms influence a patient's general physical and psychological condition comprising his body function, activity, mobility, working ability, relations with other people, sleep, life satisfaction, mood..., and to which extent the influence of the health symptoms on his general condition evolve with time.

In another embodiment, said query comprises one or more questions selected from clusters of questions for evaluating the level (severity) of pain. Said cluster of questions comprises one or more questions for measuring:
to which extent the individual estimates that said pain influences his general physical and psychological condition comprising his body function, activity, mobility, working ability, relations with other people, sleep, life satisfaction, mood . . . , and to which extent the influence of the pain on his general condition evolve with time;
to which extent the caregiver estimates that said pain influences a patient's general physical and psychological condition comprising his body function, activity, mobility, working ability, relations with other people, sleep, life satisfaction, mood . . . , and to which extent the influence of said pain on his general condition evolve with time.

In another embodiment, said query comprises one or more questions selected from clusters of questions for characterizing the typology and localisation of pain. Said cluster of questions comprises one or more questions for defining:
the painful areas,
how the individual translates pain in terms and qualifications such as painful cold, burning, electric shocks, mechanical shocks, tingling, pins, needles, numbness, itching etc.
the physical status of the painful area such as hypoesthesia to touch, hypoesthesia to prick, pain caused or increased by mechanical actions on the body such as brushing, pinching etc.

In a further embodiment, said query comprises one or more questions chosen from any of the clusters of questions as outlined above. The clusters as described above may come in the form of questionnaires known in the art (e.g. big Five, Belief in Just World, etc.) or may comprise questionnaires that are specifically designed by the inventors of the current invention.

The Scoring Factor describing the propensity of a placebo response will preferably be computed by a mathematical function of the input data. Said model will be built such that based on the input data, the propensity of the placebo effect may be calculated for each tested individual.

The current method thereto offers one or more algorithms which allow correlation of the input data with the propensity of having a placebo effect. By preference, said mathematical model is computer implemented.

Let P be a population defined by a n-row and p-columns matrix X of input data and a n-sized Y vector of observed placebo responses. Each of the n rows of X corresponds to a patient. Each of the p columns of X corresponds to a trait i.e. a personality trait. A signature S is defined as a subset of the p input traits. S is of size p′ smaller or equal to p. S is used to define a new n-rows and p′-rows matrix called X′ which together with Y defines P′.

A model estimation occurs on P′. The resulting model is called M. M is a function which maps a vector x of size p′ to an output y. This output y is the predicted placebo response, in the current invention being the Scoring Factor.

Traits

The p traits constituting the columns of matrix X described herein were identified by a skilled person based on current understanding of different aspects potentially related to placebo effect, and commonly collected with existing questionnaires and/or tests. A person of the art will understand that the traits captured by such queries and/or tests might be captured as well by other but similar queries or tests. Thus queries and/or tests capturing the same traits but formulated differently than herein described may be employed in X as well instead of restricting the definition of X to the questionnaires and/or tests described above.

Type of Prediction

In one embodiment, entries of the Y vector are binary variables corresponding to placebo responders and non-responders respectively.

In another embodiment, entries of the Y vector are ordinal variables with a finite number of modes corresponding to different placebo response levels (for example non-responders, low responders, mild responders, strong responders).

In another embodiment, entries of Y are continuous variables corresponding either to placebo response likelihood or placebo response intensity.

In another embodiment entries of the y vector are categorical variables with a finite number of modes corresponding to different forms of placebo responses.

Model

In one embodiment, the model M has the form of a linear model for regression or classification.

In another embodiment, the model M has the form of a k-Nearest Neighbour.

In yet another embodiment, the model M has the form of a decision tree.

In another embodiment, the model M is a set of models of the forms defined above built on various sub-samplings of the columns and or rows of P′.

Alternatively, classification or regression can be achieved using other mathematical methods that are well known in the art.

In all cases, the sensitivity and specificity trade-off of the models can be tuned via a meta parameter according to the applicative context. The current invention covers all possible trade-offs.

As described herein, methods to predict a placebo response or to identify individuals more likely to respond to placebo, is not meant to imply a 100% predictive ability, but is meant to indicate whether individuals with certain traits are more likely to experience a placebo response than individuals who lack such characteristics. However, as will be apparent to one skilled in the art, some individuals identified as more likely to experience a response may nonetheless fail to demonstrate measurable placebo response. Similarly, some individuals predicted as non-responders may nonetheless exhibit a placebo response.

By preference, attribution of the Scoring Factor is computer implemented. The latter allows quick and accurate analysis of input data. In one embodiment, said attribution can be performed on a place remote from of the site of data collection. Said data can be obtained on one specific site and transferred to a second site (e.g. via electronic ways, systems stored in the cloud, etc.), where data analysis and Scoring Factor attribution occurs.

Hence, the current invention also relates to a computer implemented method for predicting a placebo response in an individual. By preference, said computer implemented method comprises:

(a) inputting data obtained from personality and health-related queries, social learning and/or (bio)physical test performed by an individual; input data(b) computing a measure of propensity to respond to a placebo effect.

In an embodiment, one or more correlations may be calculated between the input data. Said ‘correlation or correlations’ is to be understood as the relationship between each of the individually collected data points or the whole data collection with the feature to be investigated. Said correlation may equally be understood as the mutual relationship of the collected data with said feature. In the current invention, the feature to be investigated is the propensity to respond to a placebo effect, which will be defined by virtue of an attributed Scoring Factor.

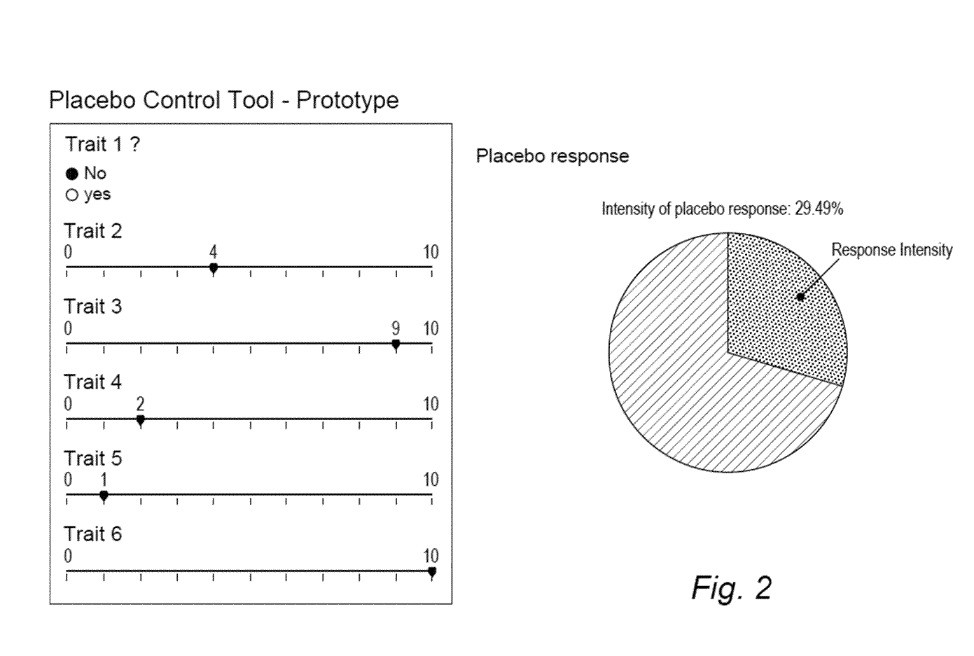

A screenshot of a possible embodiment of a computer implemented interface according to the current invention is shown in FIG. 2. Based on certain input traits, the intensity (Scoring Factor) of a placebo response is predicted. In the embodiment as shown in FIG. 2, the Scoring Factor is given by means of a percentage.

In a further aspect, the current invention also relates to a computer program product for predicting of a placebo response in an individual. By preference, said computer program product comprises at least one computer-readable storage medium having computer-readable program code portions stored therein, the computer-readable program code portions comprising instructions for comparing data obtained from personality and health-related queries, social learning and/or (bio)physical tests performed by an individual and/or with a data collection obtained from previously tested individuals, thereby computing a Scoring Factor for said individual, whereby said Scoring Factor is a measure of propensity to respond to a placebo effect.

In a further embodiment, the input data from said individual, as well as the Scoring Factors thereof may be stored in a database; said database may be stored on an external server. Such database may serve for further analysis and for further fine-tuning of the algorithms and queries used for determining said Scoring Factor. In another embodiment, query or queries used are equally stored on an external server. The latter allows third parties to make use of the methodology and system, e.g. by remotely logging in to the system. In another more preferred embodiment, said database and queries are applicable for cloud computing and being stored and/or computed in the cloud.

In a preferred embodiment, the obtained Scoring Factor and optionally the imputed test and/or query results will be summarized in a report, said report may be a digital report sent to the person making use of the methodology.

The method of the current invention is specifically useful for predicting a placebo effect in an individual or for predicting the propensity of an individual to raise a placebo response, said individual suffering from or prone to a therapeutic indication where a placebo is used as comparator in clinical development trials or where a placebo effect is found relevant for said therapeutic indication. More in particular, it is related to indications where a high rate of placebo response has been detected. These indications may include but are not limited to developing asthma, depression, Peripheral Neuropathic Pain, chronic pain, terminal cancer, a neurodegenerative condition, a spinocerebellar ataxia, encephalopathy, or other condition causing cerebellar degeneration, congestive heart failure, muscular dystrophy, cirrhosis of the liver, Parkinson's disease, schizophrenia, Huntington's disease, multiple sclerosis (MS), amyotrophic lateral sclerosis (ALS), osteoarthritis, rheumatoid arthritis or other form of arthritis, diabetes mellitus, emphysema, macular degeneration, or glomerulonephritis.

The latter indications are known to have a link with a placebo effect. Hence, by implementing the current invention in view of these therapeutic indications, treatment of a patient may be optimised, unnecessary treatments may be avoided and side-effects may be minimised. Therefore the current invention also relates to a method of identifying individuals for a therapeutic treatment based on their propensity to respond to a placebo effect, thereby predicting a Scoring Factor according to the method as described above.

In another, preferred embodiment, said method is particularly useful for predicting a placebo effect or response in an individual suffering from or prone to developing a pain disorder. It was found that especially in the field of pain treatment; the placebo effect may be for over 50% responsible for the ‘activity’ of an administered pain-management drug.

The method of the current invention is specifically useful for predicting a placebo response in an individual suffering from or prone to a pain disorder where a placebo is used as comparator in clinical development trials or where a placebo effect is found relevant for said pain disorder. More in particular, it is related to pain disorders where a high rate of placebo response has been detected.

The methodology according to the current invention can be applied in a fast way, if necessary even multiple times a day. This is a big amelioration with regard to the methodologies currently been used, which are tedious and require a significant amount of time. The methodologies used to date to evaluate a possible placebo response do not allow multiple testing on one day.

In that respect, the methodology according to the current invention can be performed within a time frame of about or less than 3 hours, preferably less than 2 hours, more preferably less than 1 hour. More preferably, said methodology can be performed at least two times a day, e.g. 2 or 3 times a day. Said methodology according to the current invention can be performed multiple times a week, at least 7 times a week, more preferably 8, 9, 10, 11, 12, 13, 14, 15, 16, 17, 18, 19, 20, 21, etc. or more times a week.

The methodology according to the current invention comprises less than 250 questions and/or tests which have to be completed by the individual, more preferably 160 questions and/or tests or less than 160 questions and/or tests, more preferably less than 100, more preferably between 1 and 99 more preferably between 1 and 90, more preferably between 1 and 80, between 1 and 70, between 1 and 60, between 1 and 50, less than 50, less than 40, less than 30, between 1 and 20, less than 20, between 1 and 15, less than 15, between 1 and 10.

As a result thereof, the methodology can be performed in a very fast manner, without causing any undue burden to the individual or patient.

In a further aspect, the method of the current invention may be equally used for selecting participants in a clinical trial. As used herein a “clinical trial” or “clinical study” is to be understood as encompassing all types of health-related studies in which obtaining data regarding safety and efficacy is a pre-requisite. As such, said clinical trial or study may refer to any research study, such as a biomedical or health-related research study, designed to obtain data regarding the safety or efficacy of a therapeutic treatment such as a drug, device, or treatment. Said clinical trial or study may equally relate to epidemiological or observational studies, market studies and surveys.

Such studies can be conducted to study fully new drugs or devices, new uses of known drugs or devices, or even to study old or ancient treatments that have not been used in Western-style medicine or proven effective in such studies. Clinical studies frequently include use of placebo treatments for one group of individuals. Clinical studies are in some embodiments conducted as double blind studies wherein the individuals do not know whether they received a putative active ingredient or treatment for the condition being tested, or a placebo with no known physiologic effect on the condition. In addition, in such double-blind studies, the researchers collecting the data also do not know which individuals received placebo or active treatment. Double blind studies help prevent bias for or against the test treatment. Moreover, while the use of placebos can help prove the efficacy of new drugs, if a research study turns out to include many people who respond to the placebo, it is much more difficult to establish the efficacy of what may well be a worthwhile therapeutic compound. Another pitfall is that on small cohorts (typical phase I and II), the distribution of the placebo-responders is very likely unbalanced. This might turn out to favour or disfavour the treatment under study, but in any case, it represents a lack of control over the placebo response.

Hence, clinical trials often suffer from the fact that obtained data and conclusions made thereof are stained by the influence of the placebo-effect which was not (or not adequately) taken into account. As a consequence, the obtained results might lack reliability. Often the problems are traced back to an inadequate selection of participants or non-optimised stratification of the participants in the trial. By starting with incorrectly stratified or non-optimal groups of participants, the whole set-up of the trial may be compromised. Hence, there is thus a need in the art for an improved method for selecting participants for a clinical trial or for allocating a trial's patient into various arms of the trial.

Said method for selecting or managing participants of a clinical trial comprises preferably the following steps:

(a) establishing at least one inclusion and/or exclusion criterion for the clinical trial that encompasses a measure of a participant's propensity to respond to a placebo;

(b) eliminating, a priori, from the clinical trial any participant who does not meet the required criteria for inclusion or exclusion.

In an embodiment of the current invention, said clinical trial relates to a pain disorder.

For the purpose of the current invention, said managing includes allocation of participants in a balanced way into various arms of the trial.

In a preferred embodiment, a measure of propensity to respond to a placebo effect is predicted according to the method as described above. By preference, said only those candidates will be selected which show a Scoring Factor conform to or within a specific predefined range or profile.

Because of the potential for added time or expense to qualify a candidate for a clinical study, it is useful to first establish that the candidate is otherwise qualified to be a participant in the clinical trial based on the inclusion and exclusion criteria for the clinical trial. It is also useful in some applications of the methods that likelihood of being prone to a placebo effect be used as an additional criterion for inclusion in, or exclusion from, the study or for allocating a participant into a specific arm of the trial.

In an embodiment, said clinical trial relates to a pain disorder.

As a consequence, the current invention also relates to a drug approved for the therapeutic treatment by a regulatory agency, said drug has been tested in one or more clinical trials whereby said participants were selected according to abovementioned method.

In a further preferred embodiment, said drug is approved for the therapeutic treatment of a pain disorder. Such drug may include, but is not limiting to paracetamol, non-steroidal anti-inflammatory drugs, COX-2 inhibitors, opioids, flupirtine, tricylic antidepressants, selective serotonin and norepinephrine reuptake inhibitor, NMDA antagonists, anticonvulsants, cannabinoids, adjuvant analgesics, such as nefopam, orphenadrine, pregabalin, gabapentin, ketamine, cyclobenzaprine, duloxetine, scopolamine or any combination of the latter.

In another aspect, the current invention also relates to a method of improving data analysis of data from a clinical trial for a therapeutic treatment. Said method of improving data analysis of data from a clinical trial for a therapeutic treatment comprises the steps of:

(a) obtaining a set of raw clinical data;

(b) evaluating the raw clinical data by standard methods to generate preliminary results;

(c) obtaining the identity for each participant in the trial (i.e. unblinding the data);

(d) assessing the likelihood of a placebo response in each participant according to the methodology and/or the computer program described above;

(e) creating a modified clinical data set by modifying the raw clinical data by retraction of said placebo effect for each participant.

In a preferred embodiment, said treatment is a therapeutic treatment of a pain disorder.

The skilled person will appreciate that step (a) is a prerequisite to the method, in that the method cannot be applied until clinical trial data are available, e.g. a clinical trial is either complete, or underway to at least the point of an initial data collection. It is to be understood that step (b), i.e. evaluating the data by standard methods is not essential to the method and may be eliminated however, it is believed it will be generally employed by the researchers or analysts and generally expected by regulators.

In step (d), the predisposition of the participants to be responsive to a placebo effect and, accordingly, to raise a placebo response is determined by the method described above. The participants are attributed a Scoring Factor as defined above. The results pertained to those participants who have a Scoring Factor conform to or within a specific predefined range, or conform to one or more inclusion and / or exclusion criterions, are identified, eliminated, or statistically adjusted to account for the fact that these were likely to be prone to a placebo effect or to raise a placebo response during the clinical trial. The skilled person will understand that the data modified (identified, eliminated, or statistically adjusted) will be those related to the clinical trial for those participants. Data that would not be modified would include data not related to a likely placebo effect. Also not modified would be the collected data and basic factual information relating to likely be prone to a placebo effect (e.g. raw data would remain intact).

Data that may be modified would include response data to the therapeutic treatment or placebo. The least preferable modification is to merely identify suspect data that comes from a likely placebo effect, for example with a series of footnotes or other explanatory notes. If the data for a likely placebo effect can be eliminated from the data set without compromising the integrity of subsequent statistical analyses, that may be most preferred. Alternatively, data for individuals likely to be prone to a placebo effect may be statistically adjusted. Statistical models are available and skilled persons will be readily able to apply appropriate or suitable statistical adjustments to the collected data to allow the modified data set to be created.

In an alternative step (e), or additional step (f) modified data are created by suppressing or re-interpreting the results of the individuals which were wrongly attributed to a specific arm of the trial or which caused unbalanced arms. By creating fair comparative arms (e.g. arms with balanced placebo effect), the data can be normalised.

The method described above is equally suitable for improving the data quality arising from clinical trials by reassessing this data on a regular basis on an individual's placebo effect and its propensity to raise a placebo response, including its response drift/shift during the treatment. This can happen at the end of the clinical trial, but preferably reassessment is done on a regular basis throughout the course of the clinical trial on the basis of the response of the individual.

A much clearer picture of therapeutic efficacy of a treatment may emerge from the study or analysis of the modified clinical data as compared to the understanding that comes from the raw data. By eliminating or adjusting for the likely placebo effect or the response shift/drift in the placebo response, confounding effects may be removed.

In some embodiments, the methods comprise a further step of comparing the preliminary results and the modified results to generate a comparison, and optionally using the comparison in connection with seeking approval from a reulalatory agency.

In another aspect, the current invention relates to a method of identifying individuals for a therapeutic treatment based on their propensity to respond to a placebo effect, the method comprising the prediction of a Scoring Factor according to the methodology and/or computer system as described above.

For this aspect of the invention, the therapeutic treatment comprises for example a modified or reduced dosing regimen, a modified or reduced time of therapeutic treatment, a therapeutic treatment with fewer side effects than a standard of care therapy, an alternative to a standard of care therapy, or a placebo.

Because the method is selecting for likely placebo responders, it is expected that for certain therapeutic treatments with active ingredients, lower dosages, shorter time courses, and/ or lower circulating blood levels of active ingredient, or the like may work as well or provide the same clinical benefits in the likely placebo responders as higher doses, longer time courses, and/ or higher circulating blood levels of active ingredient work in non-placebo responders. Because populations of likely placebo responders could not previously be determined a priori, it was not possible to consider the benefits that could accrue to this population such as reduced side effects, reduced exposure time, reduced clearance periods, as well as the potential benefits for medical providers of reduced costs for such populations. Surprisingly, as a result of the inventor's discovery, clinical trials designed to test such hypotheses are now possible.

Such methods may have particular benefits where an individual is suffering from a health-related condition comprising anxiety, or depression or an anxiety-related or depression-related disorder, a neuropathy, or chronic pain and where the therapeutic treatment is for treating the condition. Since likely placebo responders are more likely to notice and/or report improvements in their personal state of anxiety, depression, or pain (in theory by being more readily in the “experiencing self”)—it is expected that these and related types of conditions would be well suited to therapeutic treatment according to the method.

These methods are meaningful for scientifically clarifying the therapeutic role of a proposed therapy by eliminating or minimizing confounding results, and accordingly are valuable to the pharmaceutical industry and for the regulatory agencies tasked with ensuring that new drugs and other therapeutic treatments are safe and effective. The methods generally comprise the steps of assessing a Scoring Factor of a candidate thereby determining the likelihood that the candidate will respond to a placebo based on the estimation.

The current invention equally relates to a companion diagnostic tool. Said companion diagnostic tool is to be understood as a tool to predict whether a patient will respond to a certain therapy. In an embodiment, said companion diagnostic tool according to the current invention is a companion diagnostic tool for predicting a placebo effect in an individual. Said tool preferably comprises instructions for computing a Scoring Factor for said individual, whereby said Scoring Factor is a measure of propensity to respond to a placebo effect, based on data obtained from personality traits and/or health traits and/or social learning tests and/or on or more (bio)physical tests performed by said individual.

The latter will help improve patient outcomes and decrease healthcare costs. For patients with a certain disease, those that are identified as “not likely to respond” can quickly move on to other—perhaps more effective—therapies if they exist.

Furthermore, the companion diagnostic tool according to the current invention helps the healthcare system save costs by identifying the patient population that will most likely benefit from the therapy, and ruling out therapies that are not likely to be effective. This is especially important as some higher-priced therapeutics (e.g. for cancer) enter the market. An additional benefit can be realized by decreased costs related to managing side effects or hospitalizations due to unnecessary treatments.

In another aspect, said current invention relates to the use of the companion diagnostic tool as described above for patient specific treatment or for stratification of individuals in view of a clinical trial for a specific treatment, preferably for a pain disorder.

As outlined above, the tool may be used for deciding on the optimal treatment of a patient. Secondly, said tool may also serve to classify/stratify individuals enrolled in a clinical trial or specific treatment. Prior to being enrolled in a clinical trial, the propensity of a placebo effect being present may first be evaluated in an individual, after which it may be decided in which group the individual may be categorized.

In another embodiment, said companion diagnostic tool will be useful as a tool for predicting whether or not, during a treatment or a trial, the outcome of the trial is void of a placebo response (including shift/drift). The tool according to the current invention is fast and reliable, can be used multiple times throughout the course of the trial and is suitable for qualifying and/or quantifying a placebo response drift/shift.

Finally, the current invention equally relates to a set of questions or queries, or a combination of the latter, for use in either a method as described above, or for a companion diagnostic tool as explained above.

The invention will further be described by examples which are not limiting for the invention.

### EXAMPLE 1

Description of a clinical study aimed to collect the “input variables/data” and to estimate real values of a placebo response in an experimental situation where the level of placebo response can be evaluated a posteriori

The first example was aimed to collect among a sample of patients with neuropathic pain i.e.,
the input variables deemed a priori to be essential for predicting a placebo response and
a real estimation of a placebo response measured in specific situations where the level of placebo response can be evaluated.

This Example 1 was aimed to show that the input variables/data, in the absence of the method and tool of the invention, are not able to predict the placebo response of such patients.

Thus a clinical study has been conducted [hereafter Clinical study A]. Clinical study A had as objective to predict an individual placebo response (the Scoring Factor) after investigating the relationship between the patient's profile (as defined by his/her medical history, personality traits, expectation or general characteristics like age, Body Mass Index (BMI), ...) and his/her placebo response. The study was performed in the field of peripheral neuropathic pain, and is deemed to serve as a model for other fields of applications.

The patients were subjected to 245 questions or queries known in the art [212 queries (expressing several trait variables and pain symptoms) have been asked before placebo treatment and 33 queries were repeated during the study]; the answers to these questions were defined as the “input data/variables”. These variables were found to be unable to predict a placebo Score (Scoring Factor) as such (that is, without any mathematical modelling), only a description of the individual is provided. In a further attempt, the variables were used in mathematical modelling approaches in order to arrive to a predictive score.

The inventors of the current invention then surprisingly found that the number of input variables can be limited, resulting in a less tedious test for the patients, thereby still allowing an accurate and precise prediction.

Randomization

The study was performed on 41 patients.

Patients were stratified based up on 4 different traits of personality in 2 cohorts. Patients in Cohort 1 followed the studied placebo-reinforcing procedure consisting of positive expectation directed information about T4P1001 drug (in fact placebo pills), positive social observational learning and modulation of pain conditioning. Accordingly, the enrolling Investigator communicated expectation of treatment improvement to patients. Each patient watched a video presenting T4P1001 (placebo) drug properties and describing heat pain procedure, pre-treatment stimuli and modified post-treatment pain stimuli. The patient was then undergoing pre-treatment heat pain stimuli. After the pain stimuli, patients received their first placebo capsule and underwent a new heat pain conditioning approximately one hour after dosing. The post-treatment heat pain conditioning protocol was intentionally modified from the pre-treatment one as the mean intensity was reduced to induce a patient's belief in analgesic efficacy.

Patients randomized to Cohort 2 followed the sham procedure consisting of no expectation improvement, neutral social observational learning and no modulation of pain stimuli. Accordingly, the enrolling Investigator communicated neutral information about the treatment. Patients watched a video presenting neutral properties of T4P1001 drug (in fact placebo pills) and describing only the pre-treatment heat pain procedure without post-treatment stimuli. They underwent a pre-treatment heat pain stimulus protocol and they received their first placebo capsule thereafter. Approximately one hour after dosing, they underwent a post-treatment heat pain stimulus intentionally set at the same intensity as before dosing.

A posteriori evaluation of the placebo response of the included patients

This study design permitted to establish an estimation of the “really experienced” placebo response a posteriori for each of the patients included in Cohort 1 and Cohort 2. Said a posteriori estimation will be used in Examples 2 and 3 for testing the ability of the Scoring Factors on the invention to correctly predict a placebo response (by comparison of the a posteriori response with the obtained Scoring Factor).

Thus, the a posteriori placebo response has been measured by monitoring the patient's change from baseline of pain severity after treatment, as measured by the Weekly mean of the daily Average Pain Scores (APS) in the last 24 hours. In practice, the intensity of pain using the Average Pain Score (APS) has been measured as follows: Patients of both cohorts assessed every day their pain intensity in a diary by answering the question “Could you please indicate us how was your average pain during the last 24 hours? For this, circle the most descriptive number on this scale” [i.e;., a 11 NRS scale ranging from 0 (no pain) to 10 (pain as bad as you can imagine)].

The average Weekly means of the APS [WAPS] were calculated for each of the 41 patients both before [baseline] and after the treatment [placebo pill+placebo-reinforcing procedure (for the patients in cohort 1); placebo pill+neutral procedure (for the patients in cohort 2)].

It is well-known to the skilled person of the art that, for patients receiving a placebo drug/pill, when the change of the WAPS from baseline (ΔWAPS) is >0 on the 11 NRS scale, this means that pain had increased at the end of the study compared to the baseline. When the change of the WAPS from baseline (ΔWAPS) is <0, this means that pain decreased at the end of the study. When the decrease of WAPS is >1 (thus when ΔWAPS is lower than −1, e.g., ΔWAPS=−1.5, −2.0, −5.3 to give some numerical examples) this indicates not only a significant pain decrease at the end of the study but also a significant contribution of the placebo effect to the response of the patient to the pain treatment. Thus in the Examples 2 and 3, when AWAPS values are <-1, this indicates that there is a placebo response.

In the clinical study of Example 1 [41 randomized patients], 24 patients had a ΔWAPS >0 [pain have increased after the treatment] and 17 patients had a ΔWAPS <0 [pain have decreased after the treatment]. Among the latter 17 patients, 11 patients had a decrease of WAPS >1 indicating that they were in fact placebo responders.

Description of the Questions and Tests Performed to Collect the Input Data/Variables

To each of the 41 patient, 212 queries (expressing several trait variables and pain symptoms) have been asked before placebo treatment and 33 queries were repeated during the study. These queries have been selected among the clusters of validated questionnaires known in the art. The answers of the patients to each of the 245 questions have been scored on a scale from 0 to 5 (scaled responses) or 0 to 10 (4 questions).

The following table lists the main category of queries that have been asked to the patients.

TABLE 1.1
Types of questionnaires and questions selected from clusters of
questions used to collect the “input variables/data”

| | | Number |
|---|---|---|
| | | of such |
| | | questions |
| Type of | Clusters of questions to which | used in |
| Questionnaire | the questionnaires are related | the study |
| Perception of health | Cluster of questions for evaluating | 18 |
| related issues | the attitudinal and emotional | |
| | response of the patient to e.g.: | |

external factors such as the
level of control of powerful
others on his attitude to resist,
fight and overcome pain;
internal factors such as the level
of control that the individual
believes to have on his life

| | | |
|---|---|---|
| Big Five Components | Cluster of questions for | 85 |
| | characterizing the patient's | |
| | personality traits or characteristics | |
| | which are stable over time and | |
| | attributable to the person itself and | |
| | not to the effect of its environment | |
| | e.g., | |

Extraversion,
Agreeableness,
Conscientiousness,
Openness,
neuroticism

| | | |
|---|---|---|
| Suggestibility | Cluster of questions related to the | 12 |
| | impact of the | |
| | surrounding/environment on | |
| | health-related and/or psychological | |
| | issues e.g.: | |

Sensation of contagion,
Factors likely to influence the
balance between deliberate and
automatic processing of
information on pain

| | | |
|---|---|---|
| Influence of the | Cluster of questions related to the | 20 |
| Clinical settings | impact of the surrounding e.g.: | |

Anxiety,
Fear
Discouragement, hopelessness

| | | |
|---|---|---|
| Belief in a Just | Cluster of questions for evaluating | 6 |
| World | the impact of the patient's | |
| | environment on his belief of a just | |
| | world, psychological well-being, | |
| | psychological quality of life, life | |
| | satisfaction, resistance to stress | |
| | etc. | |
| Expectation | Cluster of questions for measuring | 4 |
| | the patient's expectations and | |
| | desire with respect to an external | |
| | stimulus, positive and negative | |
| | outcomes of an | |
| | intervention/treatment. | |
| Pain Compliance | Perceived doctor-patient | 26 |
| Questionnaire (PCQ) | relationship, | |
| | Positive beliefs on analgesics, | |
| | Partner agreement | |
| Severity of health | Intensity, interference, medication | 37 + 33 |
| symptoms | | |
| Caregiver Assessment | Evaluation of the patient's | 2 |
| of symptoms | condition | |
| Patient Assessment | Evaluation of the patient's | 2 |
| of health | condition | |

| | |
|---|---|
| Total number of questions used during the whole study period | 245 |

Example of queries asked relating to an individual's expectations, evaluate an individual's attitudinal and emotional response:
How much do you expect this treatment will change your current pain?
How strong is your desire for pain relief?

Examples of queries that have been asked relating to an individual's personality traits and the impact of its surroundings
I think I'm tending to find fault with others.
I think I have a forgiving nature.

Examples of queries that have been asked relating to an individual's personality traits (“extraversion”)
I think I have an assertive personality
I think I'm outgoing, sociable

Examples of queries that have been asked relating to “the evaluation of the attitudinal and emotional response of an individual to external stimuli”
I control my health.
Doctors control my health.

Examples of queries that have been asked relating to “the impact of an individual's environment on health-related and/or psychological issues”
I feel that people treat me fairly in life.
I feel that my effort are noticed and rewarded.

Examples of queries that have been asked relating to the level of health symptoms (“self-assessed health”)
“If you take into consideration all the various ways the pain influence you and your life how do you then evaluate your condition over the last week?”.

In total, 245 response scores (on a scale of 0 to 5 or 0 to 10, e.g. Likert Score) where collected for each patients examined (21 receiving a conditioning placebo and 22 receiving neutral information). For each patient, the time needed to collect the answers to all the queries has been estimated to be approximately 3 hours.

As such, the biophysical scores and the answers to the queries are not able to provide a single scoring value of the placebo response. The collected data are able to provide a caregiver with a general description of a patient, but not more.

There are no indications as such that can predict the propensity of these patients to have a placebo response, thus to predict a placebo response, in particular to

### EXAMPLE 2

### Comparison Between the Prediction of the Placebo Response of the Patients in Example 1 (the Scoring Factor) and Their Real Placebo Response Measured a Posteriori

### EXAMPLE 2.1

### Use of a Linear Regression Algorithm (LRA) for Generating a Scoring Factor by Using the Input Variables Collected in Example 1

Example 2.1 shows the ability of a linear regression algorithm such as LRA-1 (see below) to use the data [demographic data, answers to the 212 queries at baseline and the data from the biophysical test of Example 1] collected among 30 patients (out of the 41 patients included in the Clinical Study A of Example 1) in order to predict a placebo response [the Scoring Factor] for each of the 30 patients.

LRA-1 Used:

f(x)=−(−6.309+0.030*x1+0.268*x2+1.308*x3−0.058*x4+0.031*x5−0.220*x6+0.297*x7)→ŷ

where:
f(x)→ŷ,
   ŷ being the Scoring Factor
   y is the “real” placebo response based on the variation of the WAPS score [AWAPS]
   f(x) is the model, a function of x, and

x are the input variables, x={x1=[Age], x2=[Expectation], x3=[Agreeableness], x4=[Extraversion], x5=[Internal factor of perception of health-related issues], x6=[Beliefs in a Just World], x7=[Self-assessed health]}

The LRA-1 has been used for processing the input data of 30 patients of the clinical study A and has predicted the placebo response in the form of continuous output. The corresponding Scoring Factors [named “ŷ” in the LRA-1 of the example] have been compared to the a posteriori “real” placebo response [“y”] based on the variation of the WAPS score [AWAPS]. The comparison between the Scoring Factor and the a posteriori placebo response is given in Table 2.1 The Scoring Factor in Example 2.1 is a continuous value.

TABLE 2.1
Comparison between the predicted placebo response [the Scoring Factor]
and the real placebo response measured a posteriori

| Patient | Ŷ [Scoring] | Comment | Y [ΔWAPS] | Comment |
|---|---|---|---|---|
| I019 | −3.30 | Placebo | −4.43 | Placebo |
| | | Responder | | Responder |
| I032 | −3.19 | Placebo | −5.43 | Placebo |
| | | Responder | | Responder |
| I011 | −3.12 | Placebo | −1.86 | Placebo |
| | | Responder | | Responder |
| I029 | −2.84 | Placebo | −3.00 | Placebo |
| | | Responder | | Responder |
| I049 | −2.67 | Placebo | −0.86 | |
| | | Responder | | |
| I044 | −2.21 | Placebo | −2.57 | Placebo |
| | | Responder | | Responder |
| I047 | −1.66 | Placebo | −1.29 | Placebo |
| | | Responder | | Responder |
| I038 | −1.35 | Placebo | −2.71 | Placebo |
| | | Responder | | Responder |
| I050 | −1.33 | Placebo | −2.43 | Placebo |
| | | Responder | | Responder |
| I036 | −1.23 | Placebo | −1.86 | Placebo |
| | | Responder | | Responder |
| I005 | −1.08 | Placebo | −0.57 | |
| | | Responder | | |
| I051 | −1.07 | Placebo | 0.43 | |
| | | Responder | | |
| I025 | −1.00 | | −0.71 | |
| I016 | −0.97 | | +0.29 | |
| I006 | −0.93 | | −1.43 | Placebo |
| | | | | Responder |
| I042 | −0.70 | | 0.43 | |
| I014 | −0.54 | | +0.29 | |
| I001 | −0.53 | | −0.43 | |
| I023 | −0.52 | | −0.29 | |
| I028 | −0.48 | | 0.57 | |
| I033 | −0.44 | | 0.00 | |
| I052 | −0.23 | | −2.29 | Placebo |
| | | | | Responder |
| I031 | −0.15 | | 0.00 | |
| I034 | −0.06 | | 0.14 | |
| I027 | −0.05 | | 0.00 | |
| I013 | 0.01 | | 0.86 | |
| I012 | 0.03 | | 0.14 | |
| I026 | 0.29 | | 0.00 | |
| I039 | 0.61 | | −0.14 | |
| I022 | 2.05 | | 1.14 | |

Based on the statistical analysis of the results in Table 2.1, the accuracy of the predictive value of the Scoring Factor is 0.775, measured by Pearson correlation between the Scoring Factor and the a posteriori placebo response.

In Table 2.1, when the Scoring Factor is lower than −1 which is a predefined cut-off value, this indicates the presence of a placebo response, or a high propensity of developing the latter.

### Example 2.2

### Use of a Linear Classification Algorithm (LCA) for Generating a Binary Scoring Factor by Using the Input Variables Collected in Example 1

Example 2.2 shows the ability of a linear classification algorithm such as LCA-1 (see below) to use the data [demographic data, answers to the 212 queries and the data from the biophysical test of Example 1] collected among the subset of 30 patients from the Clinical Study A of Example 1

LCA-1 Used:

f(x)=sign(−2.026+0.011*x1+0.004*x2+0.501*x3−0.128*x4+0.022*x5−0.067*x6+0.214*x7)→ŷ

where:
f(x)→ŷ,
   ŷ being the binary Scoring Factor
   y is the “real” binarized placebo response, measuring whether the decrease of WAPS score is greater than 1. When the decrease of WAPS is >1 (thus when ΔWAPS is lower than −1) this indicates not only a significant pain decrease at the end of the study but also a significant contribution of the placebo effect to the response of the patient to the pain treatment.
   x are the input variables, x={x1, x2, . . . , xn}, with x={x1=[Age], x2=[Duration of symptoms], x3=[Agreeableness], x4=[Extraversion], x5=[Internal factor of perception of health-related issues], x6=[Beliefs in a Just World], x7=[ Discouragement]}, and
   f(x) is the model, a function of x

The LCA-1 has been used for processing the input data of 30 patients of the clinical study A. The corresponding binary Scoring Factors [named “ŷ” in the LCA-1 of the example] have been compared to the a posteriori “real” binary placebo response [“y”] based on the variation of the WAPS score [ΔWAPS]. The comparison between the binary Scoring Factor and the a posteriori binary placebo response is given in Table 2.2

The Scoring Factor in Example 2.2 is a categorical value.

TABLE 2.2
Comparison between the predicted placebo response [the binary Scoring
Factor] and the real placebo response measured a posteriori.

| | | | Column 4 | |
|---|---|---|---|---|
| | | | Y [Real | |
| | Ŷ [Scoring | | binarized | |
| Patient | Factor] | Comment | score] | Comment |
| I042 | sign(−0.689) = −1 | | FALSE | |
| I022 | sign(−0.681) = −1 | | FALSE | |
| I023 | sign(−0.633) = −1 | | FALSE | |
| I033 | sign(−0.550) = −1 | | FALSE | |
| I026 | sign(−0.502) = −1 | | FALSE | |
| I039 | sign(−0.466) = −1 | | FALSE | |
| I031 | sign(−0.464) = −1 | | FALSE | |
| I025 | sign(−0.446) = −1 | | FALSE | |
| I027 | sign(−0.339) = −1 | | FALSE | |
| I001 | sign(−0.336) = −1 | | FALSE | |
| I013 | sign(−0.275) = −1 | | FALSE | |
| I012 | sign(−0.159) = −1 | | FALSE | |
| I016 | sign(−0.087) = −1 | | FALSE | |
| I034 | sign(−0.080) = −1 | | FALSE | |
| I036 | sign(−0.073) = −1 | | TRUE | Placebo |
| | | | | responder |
| I005 | sign(−0.067) = −1 | | FALSE | |
| I014 | sign(−0.023) = −1 | | FALSE | |
| I051 | sign(−0.022) = −1 | | FALSE | |
| I006 | sign(0.082) = 1 | Placebo | TRUE | Placebo |
| | | responder | | responder |
| I028 | sign(0.084) = 1 | Placebo | FALSE | |
| | | responder | | |
| I052 | sign(0.102) = 1 | Placebo | TRUE | Placebo |
| | | responder | | responder |
| I011 | sign(0.237) = 1 | Placebo | TRUE | Placebo |
| | | responder | | responder |
| I049 | sign(0.285) = 1 | Placebo | FALSE | |
| | | responder | | |
| I050 | sign(0.313) = 1 | Placebo | TRUE | Placebo |
| | | responder | | responder |
| I029 | sign(0.341) = 1 | Placebo | TRUE | Placebo |
| | | responder | | responder |
| I044 | sign(0.377) = 1 | Placebo | TRUE | Placebo |
| | | responder | | responder |
| I019 | sign(0.380) = 1 | Placebo | TRUE | Placebo |
| | | responder | | responder |
| I032 | sign(0.396) = 1 | Placebo | TRUE | Placebo |
| | | responder | | responder |
| I038 | sign(0.427) = 1 | Placebo | TRUE | Placebo |
| | | responder | | responder |
| I047 | sign(0.547) = 1 | Placebo | TRUE | Placebo |
| | | responder | | responder |

In column 4, when the ΔWAPS was <−1 then “real” binarized score [Y] was set as TRUE (Placebo responder), When ΔWAPS was >−1 then the binarized score was set as FALSE (Placebo non-responder).

Based on the statistical analysis of the results in Table 2.2, the accuracy of the predictive value of the binary Scoring Factor is 0.90.

### EXAMPLE 2.3

### Use of an Instance-Based Non-Linear Classification Algorithm for Generating a Binary Scoring Factor by Using the Input Variables Collected in Example 1

Example 2.3 shows the ability of a non-linear classification algorithm such as the 1-nearest-neighbor model presented in NCA-1 (see below) to use the data [demographic data, answers to the 212 queries and the data from the biophysical test of Example 1] collected among the 30 patients included in the Clinical Study A of Example 1. Other non-linear models including but not limited to decision trees or artificial neural networks have shown similar results.

NCA-1 Used:

f(x) is computed as follows:
The distance between a new patient x and each of the 30 reference patients is computed
The closest reference patient is chosen
His/her class (responder/non responder, observed a posteriori) is returned as prediction for the class of x

where:
f(x)→ŷ,
y being the binary Scoring Factor
y is the “real” binarized placebo response, measuring whether the decrease of WAPS score is greater than 1 [ΔWAPS<−1]
   x are the input variables, x={x1=[Age], x2=[Duration of symptoms], x3=[Agreeableness], x4=[Extraversion], x5=[Internal factor of perception of health-related issues], x6=[Beliefs in a Just World], x7=[Discouragement]},
   f(x) is the model, a function of x, and
   distances between patients are measured by the Euclidean distance between their standardized input variables

The NCA-1 has been used for processing the input data of 30 patients of the clinical study A. The corresponding binary Scoring Factors [named “y” in the NCA-1 of the example] have been compared to the a posteriori “real” binary placebo response [“y”] based on the variation of the WAPS score [ΔWAPS]. The comparison between the binary Scoring Factor and the a posteriori binary placebo response is given in Table 2.3

The Scoring Factor in Example 2.3 is a binary value.

TABLE 2.3
Comparison between the predicted placebo response [the binary Scoring
Factor] and the real placebo response measured a posteriori.

| | | | Column 4 | |
|---|---|---|---|---|
| | | | Y [Real | |
| | Ŷ [Scoring | | binarized | |
| Patient | Factor] | Comment | score] | Comment |
| I001 | FALSE (NN is I027) | | FALSE | |
| I005 | FALSE (NN is I013) | | FALSE | |
| I006 | TRUE (NN is I050) | | TRUE | Placebo |
| | | | | responder |
| I011 | FALSE (NN is I049) | | TRUE | Placebo |
| | | | | responder |
| I012 | FALSE (NN is I014) | | FALSE | |
| I013 | FALSE (NN is I005) | | FALSE | |
| I014 | FALSE (NN is I012) | | FALSE | |
| I016 | FALSE (NN is I013) | | FALSE | |
| I019 | TRUE (NN is I044) | Placebo | TRUE | Placebo |
| | | responder | | responder |
| I022 | FALSE (NN is I034) | | FALSE | |
| I023 | FALSE (NN is I042) | | FALSE | |
| I025 | FALSE (NN is I031) | | FALSE | |
| I026 | FALSE (NN is I001) | | FALSE | |
| I027 | FALSE (NN is I039) | | FALSE | |
| I028 | TRUE (NN is I036) | Placebo | FALSE | |
| | | responder | | |
| I029 | TRUE (NN is I038) | Placebo | TRUE | Placebo |
| | | responder | | responder |
| I031 | FALSE (NN is I025) | | FALSE | |
| I032 | FALSE (NN is I028) | | TRUE | Placebo |
| | | | | responder |
| I033 | FALSE (NN is I031) | | FALSE | |
| I034 | TRUE (NN is I052) | Placebo | FALSE | |
| | | responder | | |
| I036 | FALSE (NN is I028) | | TRUE | Placebo |
| | | | | responder |
| I038 | TRUE (NN is I052) | Placebo | TRUE | Placebo |
| | | responder | | responder |
| I039 | FALSE (NN is I027) | | FALSE | |
| I042 | FALSE (NN is I023) | | FALSE | |
| I044 | TRUE (NN is I047) | Placebo | TRUE | Placebo |
| | | responder | | responder |
| I047 | TRUE (NN is I044) | Placebo | TRUE | Placebo |
| | | responder | | responder |
| I049 | FALSE (NN is I028) | | FALSE | |
| I050 | TRUE (NN is I006) | Placebo | TRUE | Placebo |
| | | responder | | responder |
| I051 | FALSE (NN is I012) | | FALSE | |
| I052 | TRUE (NN is I038) | Placebo | TRUE | Placebo |
| | | responder | | responder |

In column 4, when the ΔWAPS was <−1 then “real” binarized score [Y] was set as TRUE (Placebo responder). When the ΔWAPS was >−1 then the binarized score was set as FALSE (Placebo non-responder). [NN stands for nearest neighbor].

Based on the statistical analysis of the results in Table 2.3, the accuracy of the predictive value of the binary Scoring Factor is 0.83.

### EXAMPLE 2.4

### Use of a Rule-Based Non-Linear Classification Algorithm for Generating a Binary Scoring Factor by Using the Input Variables Collected in Example 1.

Example 2.4 shows the ability of a non-linear classification algorithm such as the 1-nearest-neighbor model presented in NCA-2 (see below) to use the data [demographic data, answers to the 212 queries and the data from the biophysical test of Example 1] collected among the 30 patients included in the Clinical Study A of Example 1. Other non-linear models including but not limited to decision trees or artificial neural networks have shown similar results.

NCA-2 Used:

f(x) is computed as follows (as Presented in FIG. 2.1):
The feature at the root (top) of the tree is tested.
The test indicates in which branch the patient falls.
The next node indicates which test is to be performed next.
The reasoning is pursued up to a point where the patient reaches a leaf node (bottom).
Each leaf node corresponds to a particular category (placebo responder or not)

where:
f(x)→ŷ,
   ŷ being the binary Scoring Factor
   y is the “real” binarized placebo response, measuring whether the decrease of WAPS score is greater than 1 [ΔWAPS<−1]
   x are the input variables, x={x1=[Beliefs in a Just World], x2=[discouragement], x3=[Age], x4=[Extraversion]}
   f(x) is the model, a function of x

To make a prediction for a particular patient x, the feature at the root (top) of the tree is tested. The test indicates in which branch the patient falls. The next node indicates which test is to be performed next. The reasoning is pursued up to a point where the patient reaches a leaf node (bottom). Each leaf node corresponds to a particular category (placebo responder or not).

In a first case, the NCA-2 has been used for processing the input data of 30 patients of the clinical study A. The corresponding binary Scoring Factors [named “ŷ” in the NCA-2 of the example] have been compared to the a posteriori “real” binary placebo response [“y”] based on the variation of the WAPS score [ΔWAPS]. The comparison between the binary Scoring Factor and the a posteriori binary placebo response is given in Table 2.4

The Scoring Factor in Example 2.4 is a binary value.

TABLE 2.4
Comparison between the predicted placebo response [the binary Scoring
Factor] and the real placebo response measured a posteriori.

| | | | Column 4 | |
|---|---|---|---|---|
| | | | Y [Real | |
| | Ŷ [Scoring | | binarized | |
| Patient | Factor] | Comment | score] | Comment |
| I001 | FALSE | | FALSE | |
| I005 | FALSE | | FALSE | |
| I006 | FALSE | | TRUE | Placebo |
| | | | | responder |
| I011 | TRUE | Placebo | TRUE | Placebo |
| | | responder | | responder |
| I012 | FALSE | | FALSE | |
| I013 | FALSE | | FALSE | |
| I014 | TRUE | Placebo | FALSE | |
| | | responder | | |
| I016 | FALSE | | FALSE | |
| I019 | TRUE | Placebo | TRUE | Placebo |
| | | responder | | responder |
| I022 | FALSE | | FALSE | |
| I023 | FALSE | | FALSE | |
| I025 | FALSE | | FALSE | |
| I026 | FALSE | | FALSE | |
| I027 | FALSE | | FALSE | |
| I028 | FALSE | | FALSE | |
| I029 | TRUE | Placebo | TRUE | Placebo |
| | | responder | | responder |
| I031 | FALSE | | FALSE | |
| I032 | FALSE | | TRUE | Placebo |
| | | | | responder |
| I033 | FALSE | | FALSE | |
| I034 | FALSE | | FALSE | |
| I036 | TRUE | Placebo | TRUE | Placebo |
| | | responder | | responder |
| I038 | TRUE | Placebo | TRUE | Placebo |
| | | responder | | responder |
| I039 | FALSE | | FALSE | |
| I042 | FALSE | | FALSE | |
| I044 | TRUE | Placebo | TRUE | Placebo |
| | | responder | | responder |
| I047 | TRUE | Placebo | TRUE | Placebo |
| | | responder | | responder |
| I049 | FALSE | | FALSE | |
| I050 | TRUE | Placebo | TRUE | Placebo |
| | | responder | | responder |
| I051 | FALSE | | FALSE | |
| I052 | TRUE | Placebo | TRUE | Placebo |
| | | responder | | responder |

In column 4, when the ΔWAPS was <−1 then the “real” binarized score [Y] was set as TRUE (Placebo responder). When the ΔWAPS was >−1 then the binarized score was set as FALSE (Placebo non-responder). [NN stands for nearest neighbor].

Based on the statistical analysis of the results in Table 2.4, the accuracy of the predictive value of the binary Scoring Factor is 0.9.

Above examples show that it is possible to determine the placebo response on the basis of input variables relating to an individual by mathematical modelling.

### EXAMPLE 3

### Reduction of the Number of Questions Needed to Obtain the Same Placebo Scores as in Example 2.

Surprisingly, the inventors of the current invention learned that the number of questions asked to a patient or individual can be reduced whilst still maintaining a very accurate prediction of the placebo response. This enables a fast execution of the test, even multiple times a day/week thereby reducing any negative side-effects for the patient or individual whilst taking the test.

In a first case, all 41 patients completed the 212 queries performed at the baseline. Using feature selection techniques¹, the total number of queries related to trait personality was decreased from 167 to 117, without decreasing the number of personality traits measured. The impact of queries reduction on the measure of each personality trait was minimal (average R-squared >0.5 and p-value of signature stability<0.10).

In a second case, it was possible to reduce the number of personality traits associated to the prediction of the placebo response. As a result, a reduced subset of only 99 questions related to personality traits and less than 60 related to health were found sufficient to predict the placebo response in future patients with the same level of confidence as those obtained in Example 2.

### EXAMPLE 3.1

### Use of a Linear Regression Algorithm for Generating a Scoring Factor by Using the Reduced Set of Input Variables

This example shows the ability of a linear regression algorithm such as LRA-1 (see Example 2.1) to generate accurate Scoring Factors based on the reduced set of input variables [demographic data, answers to the 99 questions, answers to less than 60 questions related to health and the data from the biophysical test of Example 1] collected among the 30 patients included in the Clinical Study A of Example 1.

The predictive model LRA-1 has been used for generating Scoring Factors based on the input data of 30 patients of the clinical study A, with the reduced set of input variables introduced above. The corresponding Scoring Factors [named “ŷ”] have been compared to the a posteriori “real” placebo response [“y”] based on the variation of the WAPS score [AWAPS]. The comparison is given in Table 3.1

The Scoring Factor in this example is a continuous value.

TABLE 3.1
Comparison between the predicted placebo response [the Scoring
Factor] obtained on a shortlist of variables (column 2),
the Scoring Factor as obtained in Example 2.1 (column 4) and
the real placebo response measured a posteriori (column 5)

| | Column 2 | | Column 4 | | |
|---|---|---|---|---|---|
| | Ŷ | | Ŷ | | |
| | [Scoring | | [Scoring | Column 5 | |
| | Factor] | | Factor] | Y | |
| Patient | “reduced” | Comment | “Ex. 2.1” | [ΔWAPS] | Comment |
| I032 | −3.59 | Placebo | −3.19 | −5.43 | Placebo |
| | | responder | | | responder |
| I019 | −3.42 | Placebo | −3.30 | −4.43 | Placebo |
| | | responder | | | responder |
| I011 | −3.14 | Placebo | −3.12 | −1.86 | Placebo |
| | | responder | | | responder |
| I049 | −2.80 | Placebo | −2.67 | −0.86 | |
| | | responder | | | |
| I029 | −2.73 | Placebo | −2.84 | −3.00 | Placebo |
| | | responder | | | responder |
| I044 | −1.80 | Placebo | −2.21 | −2.57 | Placebo |
| | | responder | | | responder |
| I047 | −1.66 | Placebo | −1.66 | −1.29 | Placebo |
| | | responder | | | responder |
| I006 | −1.44 | Placebo | −0.93 | −1.43 | Placebo |
| | | responder | | | responder |
| I050 | −1.33 | Placebo | −1.33 | −2.43 | Placebo |
| | | responder | | | responder |
| I025 | −1.25 | Placebo | −1.00 | −0.71 | |
| | | responder | | | |
| I036 | −1.24 | Placebo | −1.23 | −1.86 | Placebo |
| | | responder | | | responder |
| I038 | −1.23 | Placebo | −1.35 | −2.71 | Placebo |
| | | responder | | | responder |
| I005 | −0.93 | | −1.08 | −0.57 | |
| I016 | −0.84 | | −0.97 | 0.29 | |
| I042 | −0.83 | | −0.70 | 0.43 | |
| I028 | −0.72 | | −0.48 | 0.57 | |
| I051 | −0.42 | | −1.07 | 0.43 | |
| I033 | −0.41 | | −0.44 | 0.00 | |
| I001 | −0.38 | | −0.53 | −0.43 | |
| I052 | −0.37 | | −0.23 | −2.29 | Placebo |
| | | | | | responder |
| I023 | −0.28 | | −0.52 | −0.29 | |
| I013 | −0.10 | | 0.01 | 0.86 | |
| I014 | −0.04 | | −0.54 | −0.29 | |
| I034 | 0.08 | | −0.06 | 0.14 | |
| I031 | 0.12 | | −0.15 | 0.00 | |
| I012 | 0.15 | | 0.03 | 0.14 | |
| I027 | 0.19 | | −0.05 | 0.00 | |
| I026 | 0.29 | | 0.29 | 0.00 | |
| I039 | 0.49 | | 0.61 | −0.14 | |
| I022 | 2.58 | | 2.58 | 1.14 | |

Based on the statistical analysis of the results in Table 2.1, the accuracy of the predictive value of the Scoring Factor is 0.787, measured by Pearson correlation between the Scoring Factor and the a posteriori placebo response.

### EXAMPLE 3.2

### Use of a Linear Classification Algorithm for Generating a Binary Scoring Factor by Using the Reduced Set of Input Variables

Example 3.2 shows the ability of a linear classification algorithm such as LCA-1 (see Example 2.2) to generate accurate binary Scoring Factors based on the reduced set of input variables [demographic data, answers to the 99 questions and less than 60 health-related questions and the data from the biophysical test of Example 1] collected among the 30 patients included in the Clinical Study A of Example 1.

The predictive model LCA-1 has been used for generating binary Scoring Factors based on the input data of 30 patients of the clinical study A, with the reduced set of input variables introduced above. The corresponding binary Scoring Factors [named “ŷ”] have been compared to the a posteriori “real” placebo response [“y”] based on the variation of the WAPS score [ΔWAPS]. The comparison is given in Table 3.2

The Scoring Factor in this example is a binary value.

TABLE 3.2
Comparison between the predicted placebo response [the binary Scoring
Factor] and the real placebo response measured a posteriori.

| | | | Column 4 | |
|---|---|---|---|---|
| | Ŷ [Scoring | | Y [Real | |
| | Factor] | | binarized | |
| Patient | “reduced” | Comment | score] | Comment |
| I022 | sign(−0.910) = −1 | | FALSE | |
| I023 | sign(−0.694) = −1 | | FALSE | |
| I042 | sign(−0.642) = −1 | | FALSE | |
| I033 | sign(−0.624) = −1 | | FALSE | |
| I031 | sign(−0.590) = −1 | | FALSE | |
| I026 | sign(−0.512) = −1 | | FALSE | |
| I039 | sign(−0.438) = −1 | | FALSE | |
| I001 | sign(−0.425) = −1 | | FALSE | |
| I027 | sign(−0.382) = −1 | | FALSE | |
| I025 | sign(−0.375) = −1 | | FALSE | |
| I051 | sign(−0.282) = −1 | | FALSE | |
| I013 | sign(−0.270) = −1 | | FALSE | |
| I012 | sign(−0.187) = −1 | | FALSE | |
| I014 | sign(−0.169) = −1 | | FALSE | |
| I005 | sign(−0.159) = −1 | | FALSE | |
| I034 | sign(−0.156) = −1 | | FALSE | |
| I016 | sign(−0.134) = −1 | | FALSE | |
| I036 | sign(−0.051) = −1 | | TRUE | Placebo |
| | | | | responder |
| I028 | sign(0.123) = 1 | Placebo | FALSE | |
| | | responder | | |
| I052 | sign(0.168) = 1 | Placebo | TRUE | Placebo |
| | | responder | | responder |
| I044 | sign(0.194) = 1 | Placebo | TRUE | Placebo |
| | | responder | | responder |
| I006 | sign(0.260) = 1 | Placebo | TRUE | Placebo |
| | | responder | | responder |
| I011 | sign(0.282) = 1 | Placebo | TRUE | Placebo |
| | | responder | | responder |
| I050 | sign(0.313) = 1 | Placebo | TRUE | Placebo |
| | | responder | | responder |
| I049 | sign(0.326) = 1 | Placebo | FALSE | |
| | | responder | | |
| I029 | sign(0.336) = 1 | Placebo | TRUE | Placebo |
| | | responder | | responder |
| I038 | sign(0.393) = 1 | Placebo | TRUE | Placebo |
| | | responder | | responder |
| I019 | sign(0.414) = 1 | Placebo | TRUE | Placebo |
| | | responder | | responder |
| I047 | sign(0.538) = 1 | Placebo | TRUE | Placebo |
| | | responder | | responder |
| I032 | sign(0.552) = 1 | Placebo | TRUE | Placebo |
| | | responder | | responder |

In column 4, when the ΔWAPS was <−1 then the “real” binarized score [Y] was set as TRUE (Placebo responder). When the ΔWAPS was >−1 then the binarized score was set as FALSE (Placebo non-responder).

Based on the statistical analysis of the results in Table 2.2, the accuracy of the predictive value of the binary Scoring Factor is 0.90.

### Example 3.3

### Use of an Instance-Based Non-Linear Classification Algorithm for Generating a Binary Scoring Factor by Using the Reduced Set of Input Variables

Example 3.3 shows the ability of a non-linear classification algorithm such as NCA-1 (see Example 2.3) to generate accurate binary Scoring Factors based on the reduced set of input variables [demographic data, answers to the 99 questions related to personality, answers to less than 60 questions related to health and the data from the biophysical test of Example 1] collected among the 30 patients included in the Clinical Study A of Example 1.

The predictive model NCA-1 has been used for generating binary Scoring Factors based on the input data of 30 patients of the clinical study A, with the reduced set of input variables introduced above. The corresponding binary Scoring Factors [named “ŷ”] have been compared to the a posteriori “real” placebo response [“y”] based on the variation of the WAPS score [ΔWAPS]. The comparison is given in Table 3.3.

The Scoring Factor in this example is a binary value.

TABLE 3.3
Comparison between the predicted placebo response [the binary Scoring
Factor] and the real placebo response measured a posteriori.

| | | | Column 4 | |
|---|---|---|---|---|
| | | | Y [Real | |
| | Ŷ [Scoring | | binarized | |
| Patient | Factor] | Comment | score] | Comment |
| I001 | FALSE (NN is I039) | | FALSE | |
| I005 | FALSE (NN is I013) | | FALSE | |
| I006 | TRUE (NN is I050) | | TRUE | Placebo |
| | | | | responder |
| I011 | FALSE (NN is I025) | | TRUE | Placebo |
| | | | | responder |
| I012 | FALSE (NN is I014) | | FALSE | |
| I013 | FALSE (NN is I005) | | FALSE | |
| I014 | FALSE (NN is I012) | | FALSE | |
| I016 | FALSE (NN is I013) | | FALSE | |
| I019 | TRUE (NN is I044) | Placebo | TRUE | Placebo |
| | | responder | | responder |
| I022 | FALSE (NN is I034) | | FALSE | |
| I023 | FALSE (NN is I042) | | FALSE | |
| I025 | FALSE (NN is I031) | | FALSE | |
| I026 | FALSE (NN is I001) | | FALSE | |
| I027 | FALSE (NN is I039) | | FALSE | |
| I028 | TRUE (NN is I036) | Placebo | FALSE | |
| | | responder | | |
| I029 | TRUE (NN is I036) | Placebo | TRUE | Placebo |
| | | responder | | responder |
| I031 | FALSE (NN is I025) | | FALSE | |
| I032 | FALSE (NN is I028) | | TRUE | Placebo |
| | | | | responder |
| I033 | FALSE (NN is I025) | | FALSE | |
| I034 | TRUE (NN is I038) | Placebo | FALSE | |
| | | responder | | |
| I036 | FALSE (NN is I028) | | TRUE | Placebo |
| | | | | responder |
| I038 | TRUE (NN is I052) | Placebo | TRUE | Placebo |
| | | responder | | responder |
| I039 | FALSE (NN is I027) | | FALSE | |
| I042 | FALSE (NN is I023) | | FALSE | |
| I044 | FALSE (NN is I039) | Placebo | TRUE | Placebo |
| | | responder | | responder |
| I047 | TRUE (NN is I019) | Placebo | TRUE | Placebo |
| | | responder | | responder |
| I049 | FALSE (NN is I028) | | FALSE | |
| I050 | TRUE (NN is I006) | Placebo | TRUE | Placebo |
| | | responder | | responder |
| I051 | FALSE (NN is I012) | | FALSE | |
| I052 | TRUE (NN is I038) | Placebo | TRUE | Placebo |
| | | responder | | responder |

In column 4, when the ΔWAPS was <−1 then the “real” binarized score [Y] was set as TRUE (Placebo responder). When the ΔWAPS was >−1 then the binarized score was set as FALSE (Placebo non-responder). [NN stands for nearest neighbor].

Based on the statistical analysis of the results in Table 3.3, the accuracy of the predictive value of the binary Scoring Factor is 0.80.

Although the illustrative embodiments of the present invention have been described in greater detail, it will be understood that the invention is not limited to those embodiments. Various changes or modifications may be effected by one skilled in the art without departing from the scope or the spirit of the invention as defined in the claims.

### Example 3.4

### Use of a Rule-Based Non-Linear Classification Algorithm for Generating a Binary Scoring Factor by Using the Reduced Set of Input Variables

Example 3.4 shows the ability of a non-linear classification algorithm such as NCA-2 (see Example 2.4) to generate accurate binary Scoring Factors based on the reduced set of input variables [demographic data, answers to the 99 questions related to personality, answers to less than 60 questions related to health and the data from the biophysical test of Example 1] collected among the 30 patients included in the Clinical Study A of Example 1.

The predictive model NCA-2 has been used for generating binary Scoring Factors based on the input data of 30 patients of the clinical study A, with the reduced set of input variables introduced above. The corresponding binary Scoring Factors [named “ŷ”] have been compared to the a posteriori “real” placebo response [“y”] based on the variation of the WAPS score [ΔWAPS]. The comparison is given in Table 3.4.

The Scoring Factor in this example is a binary value.

TABLE 3.4
Comparison between the predicted placebo response [the binary Scoring
Factor] and the real placebo response measured a posteriori.

| | | | Column 4 | |
|---|---|---|---|---|
| | | | Y [Real | |
| | Ŷ [Scoring | | binarized | |
| Patient | Factor] | Comment | score] | Comment |
| I001 | FALSE | | FALSE | |
| I005 | FALSE | | FALSE | |
| I006 | FALSE | | TRUE | |
| I011 | TRUE | Placebo | TRUE | Placebo |
| | | responder | | responder |
| I012 | FALSE | | FALSE | |
| I013 | FALSE | | FALSE | |
| I014 | TRUE | Placebo | FALSE | |
| | | responder | | |
| I016 | FALSE | | FALSE | |
| I019 | TRUE | Placebo | TRUE | Placebo |
| | | responder | | responder |
| I022 | FALSE | | FALSE | |
| I023 | FALSE | | FALSE | |
| I025 | FALSE | | FALSE | |
| I026 | FALSE | | FALSE | |
| I027 | FALSE | | FALSE | |
| I028 | FALSE | | FALSE | |
| I029 | TRUE | Placebo | TRUE | Placebo |
| | | responder | | responder |
| I031 | FALSE | | FALSE | |
| I032 | FALSE | | TRUE | Placebo |
| | | | | responder |
| I033 | FALSE | | FALSE | |
| I034 | FALSE | | FALSE | |
| I036 | TRUE | Placebo | TRUE | Placebo |
| | | responder | | responder |
| I038 | TRUE | Placebo | TRUE | Placebo |
| | | responder | | responder |
| I039 | FALSE | | FALSE | |
| I042 | FALSE | | FALSE | |
| I044 | TRUE | Placebo | TRUE | Placebo |
| | | responder | | responder |
| I047 | TRUE | Placebo | TRUE | Placebo |
| | | responder | | responder |
| I049 | FALSE | | FALSE | |
| I050 | TRUE | Placebo | TRUE | Placebo |
| | | responder | | responder |
| I051 | FALSE | | FALSE | |
| I052 | TRUE | Placebo | TRUE | Placebo |
| | | responder | | responder |

In column 4, when the ΔWAPS was <−1 then the “real” binarized score [Y] was set as TRUE (Placebo responder). When ΔWAPS was >−1 then the binarized score was set as FALSE (Placebo non-responder).

Based on the statistical analysis of the results in Table 3.4, the accuracy of the predictive value of the binary Scoring Factor is 0.90.

Although the illustrative embodiments of the present invention have been described in greater detail, it will be understood that the invention is not limited to those embodiments. Various changes or modifications may be effected by one skilled in the art without departing from the scope or the spirit of the invention as defined in the claims.

1. A method for predicting a placebo response in an individual, comprising:
receiving input data based on responses to a first set of questions querying said individual on personality and health traits;
characterizing a personality trait from a plurality of the responses from said questions, said personality trait forming part of the input data;
using a mathematical model stored on a computer for computing a correlation between the input data,
using the correlation to attribute a Scoring Factor to said individual, whereby said Scoring Factor is a measure of propensity to raise a placebo response and/or a measure of the intensity of said response,
determining a reduced number of personality traits by using a feature selection technique to determine a reduced set of questions; and
modifying the mathematical model to use the reduced number of personality traits.

2. (canceled)

3. A method according to claim 1, characterized in that said first set of questions comprises questions selected from clusters of questions or combinations of questions from different clusters, said clusters of questions:
relate to an individual's personality traits; and/or
measure or evaluate the impact of an individual's environment on health-related and/or psychological issues; and/or
measure an individual's expectations, evaluate an individual's attitudinal and emotional response; and/or
characterize the typology and localization of pain of said individual; or—evaluate the level of pain of said individual; and/or
evaluate the level of health symptoms of said individual.

4. A method according to claim 1, characterized in that said Scoring Factor is compared to a cut-off value to determine a classification whether or not a placebo response exists in an individual.

5. A method according to claim 1, characterized in that the method is performed over a period of no more than 3 hours.

6. A method according to claim 1, characterized in that said method is performed multiple times a day or week.

7. A method according to claim 1, characterized in that said mathematical model is chosen from the group of linear or non-linear models.

8. A method according to claim 1, characterized in that said individual is suffering from or prone to developing a pain disorder.

9. A method according to claim 1 further comprising predicting a placebo response in an individual suffering from or prone to a placebo-effect relevant therapeutic indication.

10. A method according to claim 9, whereby said individual is suffering from or prone to developing a pain disorder.

11. A computer implemented method for predicting the likelihood of a placebo effect or response in an individual, comprising:
(a) receiving data obtained from a first set of questions querying said individual's personality traits and health traits in a mathematical model;
(b) characterizing a personality trait from a plurality of the results from said questions, said personality trait forming part of the input data;
(c) computing a correlation between the input data, the correlation comprising a mathematical relationship between two or more random variables or data points of the input data; the model configured to analyze a first number of personality traits;
(d) computing a Scoring Factor to said individual, whereby said Scoring Factor is a measure of propensity to raise a placebo response and/or a measure of the intensity of said response;
(e) determining a reduced number of personality traits by using a feature selection technique to determine a reduced set of questions; and
(f) modifying the mathematical model to use the reduced number of personality traits.

12. A computer implemented method according to claim 11, characterized in that said Scoring Factor is compared to a cut-off value to determine a classification whether or not a placebo response exists in an individual.

13. A computer implemented method according to claim 11 or 12, characterized in that said individual is suffering from or prone to developing a pain disorder.

14. A computer implemented product for predicting a placebo response in an individual, said computer program product comprising at least one computer-readable storage medium having processor-executable program code portions stored therein, the processor-executable program code portions comprising instructions for causing a processor to:
(a) receive data obtained from a first set of questions querying said individual's personality traits and health traits in a mathematical model;
(b) characterize a personality trait from a plurality of the results from said questions, said personality trait forming part of the input data;
(c) compute a correlation between the input data, the correlation comprising a mathematical relationship between two or more random variables or data points of the input data; the model configured to analyze a first number of personality traits;
(d) compute a Scoring Factor to said individual, whereby said Scoring Factor is a measure of propensity to raise a placebo response and/or a measure of the intensity of said response;
(e) determine a reduced number of personality traits by using a feature selection technique to determine a reduced set of questions; and
(f) modify the mathematical model to use the reduced number of personality traits.

15. A computer implemented product according to claim 14, further comprising instructions to cause a processor to compare said Scoring Factor to one or more cut-off values; and based on the comparison, determine a classification of whether a placebo response is present.

16. A method according to claim 1, further comprising identifying individuals for a therapeutic treatment based on their propensity to respond to a placebo effect.

17. A method according to claim 1, further comprising: selecting or managing participants for a clinical trial comprising the steps of:
(a) establishing at least one inclusion and / or exclusion criterion for the clinical trial that encompasses a measure of a participant's propensity to respond to a placebo;
(b) eliminating, a priori, from the clinical trial any participant who does not meet the required criteria for inclusion or exclusion.

18. (canceled)

19. (canceled)

20. (canceled)

21. (canceled)
